(19) United States
(12) Patent Application Publication
(10) Pub. No.: US 2006/0059095 A1
(43) Pub. Date: Mar. 16, 2006

(54) Selecting and downloading content to a portable player

(76) Inventors: Glendon L. Akins III, Fort Collins, CO (US); Howard G. Pinder, Norcross, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/270,297

(22) Filed: Nov. 9, 2005

Related U.S. Application Data
(62) Division of application No. 10/289,051, filed on Nov. 6, 2002.

(51) Int. Cl. G06Q 99/00

(52) U.S. Cl. 705/51

(57) ABSTRACT

A system includes a memory with logic and a processor configured with the logic to receive a user request from a user to designate a content instance for download, the user request received during a presentation of the content instance, wherein the processor is further configured with the logic to, responsive to receiving the user request, effect saving of identifying indicia of the content instance.

### TECHNICAL FIELD

The present invention is generally related to television systems, and, more particularly, is related to interactive television.

### BACKGROUND OF THE INVENTION

With recent advances in digital transmission technology, subscriber television systems are now capable of providing much more than the traditional analog broadcast video. In implementing enhanced programming, the home communication terminal (“HCT”), otherwise known as the set-top box, has become an important computing device for accessing content services (and content within those services) and navigating a user through a maze of available services. In addition to supporting traditional analog broadcast video functionality, digital HCTs (or “DHCTs”) now also support an increasing number of two-way digital services such as video-on-demand and personal video recording (PVR).

Typically, a DHCT is connected to a cable or satellite, or generally, a subscriber television system, and includes hardware and software necessary to provide the functionality of the digital television system at the user's site. Some of the software executed by a DHCT can be downloaded and/or updated via the subscriber television system. Each DHCT also typically includes a processor, communication components, and memory, and is connected to a television set or other display device, such as a personal computer. While many conventional DHCTs are stand-alone devices that are externally connected to a television, a DHCT and/or its functionality may be integrated into a television or personal computer or even an audio device such as a programmable radio, as will be understood by those of ordinary skill in the art.

Interactive television has improved vastly over the years, providing the user the ability to pause, fast forward, and rewind content instances such as movies, program episodes, songs, etc., either via network based interactive mechanisms like media on demand (MOD), or via PVR mechanisms implemented using DHCTs with coupled storage devices (e.g., hard disk drives, CD-ROM, etc.). Although these interactive mechanisms provide the user the ability to control his or her viewing and/or listening experience, the user is often burdened with awkward interfaces. Thus, a need exists in the industry to address the aforementioned and/or other deficiencies and/or inadequacies.

### BRIEF DESCRIPTION OF THE DRAWINGS

The preferred embodiments of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of an example subscriber television system (STS), in accordance with one embodiment of the invention.

FIG. 2A is a block diagram of select components of an example headend as depicted in FIG. 1 and related equipment for delivering broadcast music, in accordance with one embodiment of the invention.

FIG. 2B is a timing diagram that illustrates some example interactions for saving identifying indicia of a user requested song in a subscriber playlist at the headend depicted in FIG. 2A, in accordance with one embodiment of the invention.

FIG. 3A is a block diagram of select components of an example DHCT as depicted in FIG. 1 and related equipment for receiving broadcast music, in accordance with one embodiment of the invention.

FIG. 3B is a block diagram of an example portable audio player connected to the example DHCT of FIG. 3A, in accordance with one embodiment of the invention.

FIG. 3C is a schematic diagram of an example remote control device to provide input to the DHCT illustrated in FIG. 3A, in accordance with one embodiment of the invention.

FIG. 4A is a timing diagram that illustrates example interactions between the DHCT and the headend to save identifying indicia of associated user requested songs to a playlist, in accordance with one embodiment of the invention.

FIG. 4B is a screen diagram of an example graphics user interface (GUI) screen that provides information about a currently playing song, in accordance with one embodiment of the invention.

FIG. 4C is a screen diagram of an example GUI screen that provides a confirmation to a user when identifying indicia of an associated song designated for download by a user is added to a user playlist, in accordance with one embodiment of the invention.

FIGS. 5A-5B are flow diagrams of one example method for receiving downloaded songs associated with a user playlist, in accordance with one embodiment of the invention.

FIG. 5C is a screen diagram of an example GUI screen that illustrates one example feedback mechanism for informing a user that songs associated with a user playlist are in the process of being downloaded, in accordance with one embodiment of the invention.

### DETAILED DESCRIPTION OF THE PREFERRED EMBODIMENTS

Preferred embodiments of the invention now will be described more fully hereinafter with reference to the accompanying drawings, in which preferred embodiments of the invention are shown. One way of understanding the preferred embodiments of the invention includes viewing them within the context of a subscriber television system, and more particularly within the context of a media client device, such as a digital home communication terminal (DHCT), that enables a user to listen to audio content, such as music, from a television set or other audio-type device and designate the music for download to a portable player for playback. Thus, the preferred embodiments of the invention include, among other things, systems and methods for enabling a user to designate songs for download while the user is listening to the songs. The preferred embodiments of the invention also include systems and methods for downloading all of the designated songs to a portable player upon the connection of the portable player to the DHCT. In other implementations, the songs can be played at the DHCT. Responsive to receiving a user request that designates a song, the preferred embodiments of the invention cause identifying indicia (e.g., information that identifies and/or describes the song the user is actually listening to, such as the title, artist, and/or album) of the designated song to be stored at a remote server. The identifying indicia is preferably saved, along with user-specific information, to a playlist located at a remote server (which may or may not be the same remote server that stores the corresponding songs), although the playlist may be stored locally in other embodiments. As songs are played that the user likes, he or she can continue to designate these songs using, in one implementation, an input device, which causes the corresponding identifying indicia to be saved to the playlist, which is preferably unique to each user.

When the user is ready to download the designated songs to his or her portable player (or to the DHCT), in one implementation, the user can connect a portable player, for example a portable audio player. Generally, the DHCT receives an indication of this connection, and responsively requests the remote server to download the song or songs using the information in the playlist as an index to the songs resident in the remote server. The songs are downloaded to the DHCT, and then downloaded to the connected portable audio player. Although the terms “connected” or “connection” will be described herein when referring to the interaction or interfacing between the DHCT and the portable audio player, it will be understood that practically any interfacing between the DHCT and portable audio player is within the scope of the preferred embodiments of the invention, whether the interfacing occurs via an actual physical connection or via wireless communication. Although other communication environments are considered to be within the scope of the preferred embodiments, including the use for video content and/or other audio content, the preferred embodiments of the invention will be described in the context of a DHCT that receives music from a headend over a subscriber television network as one example implementation among many.

Because the preferred embodiments of the invention can be understood in the context of a subscriber television system environment, an initial description of a subscriber television system is followed with further description of select components of a headend and DHCT that are included within the subscriber television system for the delivery and receipt of user requested music. Thus, internal communications included in implementing the preferred embodiments of the invention at the headend are described, including a description of a music server and the timing interactions between modules and databases of the music server.

Following the description of the interactions at the music server is a description of an example DHCT and interacting components and peripherals, including an example portable audio player, and a remote control device that serves as one conduit for user requests to the DHCT. This description is followed by a timing diagram that illustrates the system interactions to save identifying indicia in a playlist, as well as some example graphics user interface (GUI) screens to provide the user with some visual feedback of the saving process. Finally, a flowchart of one example method for downloading songs associated with a playlist is described, followed by an example GUI screen to provide feedback of the status of the download of the songs associated with the playlist.

The preferred embodiments of the invention may, however, be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” given herein are intended to be non-limiting, and are provided as an exemplary list among many other examples contemplated but not shown.

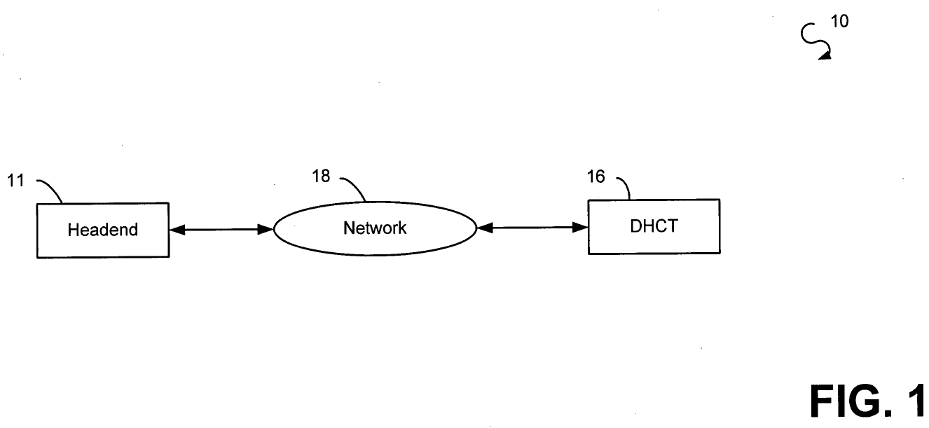

FIG. 1 is a block diagram depicting a non-limiting example of a subscriber television system (STS) 10. In this example, the STS 10 includes a headend 11 and a digital home communication terminal (DHCT) 16 that are coupled via a communications network 18. It will be appreciated that the STS 10 shown in FIG. 1 is merely illustrative and should not be construed as implying any limitations upon the scope of the preferred embodiments of the invention. For example, although single components (e.g., a headend and a DHCT) are illustrated in FIG. 1, the STS 10 can feature a plurality of any one of the illustrated components, or may be configured with alternative embodiments for any one of the individual components or with yet other additional components not enumerated above. Subscriber television systems also included within the scope of the preferred embodiments of the invention include systems not utilizing physical structured cabling for transmission, such as, but not limited to, satellite systems.

A DHCT 16 is typically situated at the residence or place of business of a user and may be a stand-alone unit or integrated into another device such as, for example, a television set or a personal computer or other display devices, or an audio device, such as a programmable radio, among other devices. The DHCT 16 receives signals (video, audio and/or other data) from the headend 11 through the network 18, and provides reverse information to the headend 11 through the network 18.

The headend 11 preferably receives content from a content provider (not shown). The headend 11 may include one or more server devices (not shown) for providing video, audio, and/or data to media client devices such as the DHCT 16. The headend 11 and the DHCT 16 cooperate to provide a user with television services via a television set (not shown). The television services may include, for example, broadcast television services, music services, cable television services, premium television services, video-on-demand (VOD) services, and/or pay-per-view (PPV) services, among others.

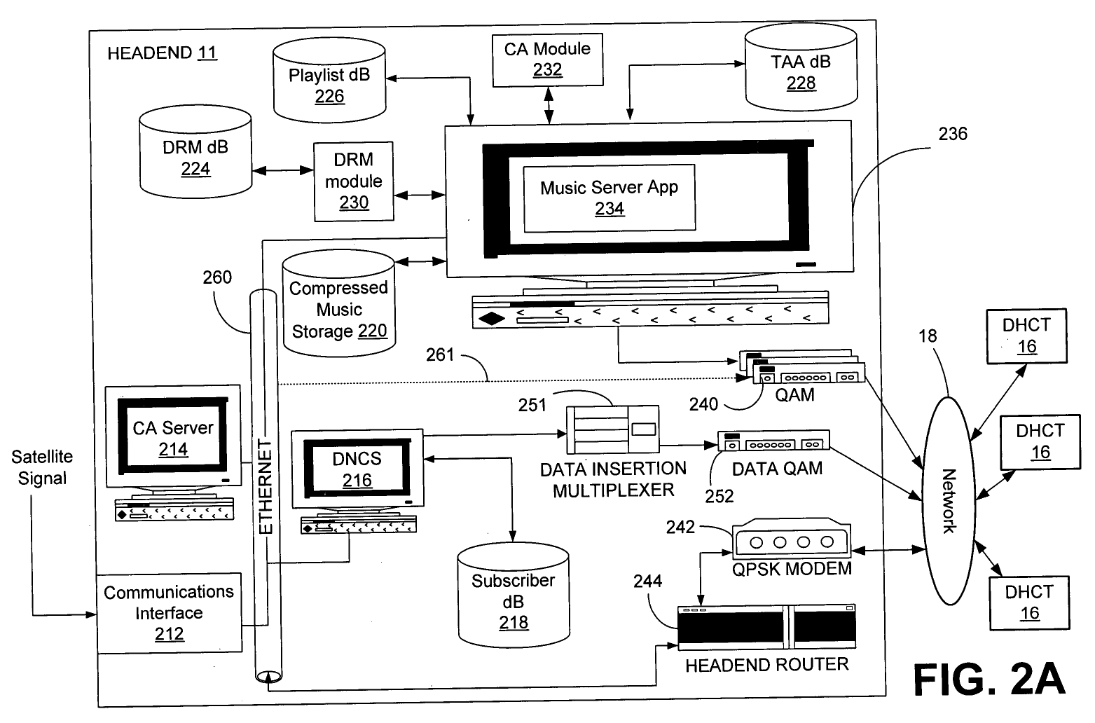

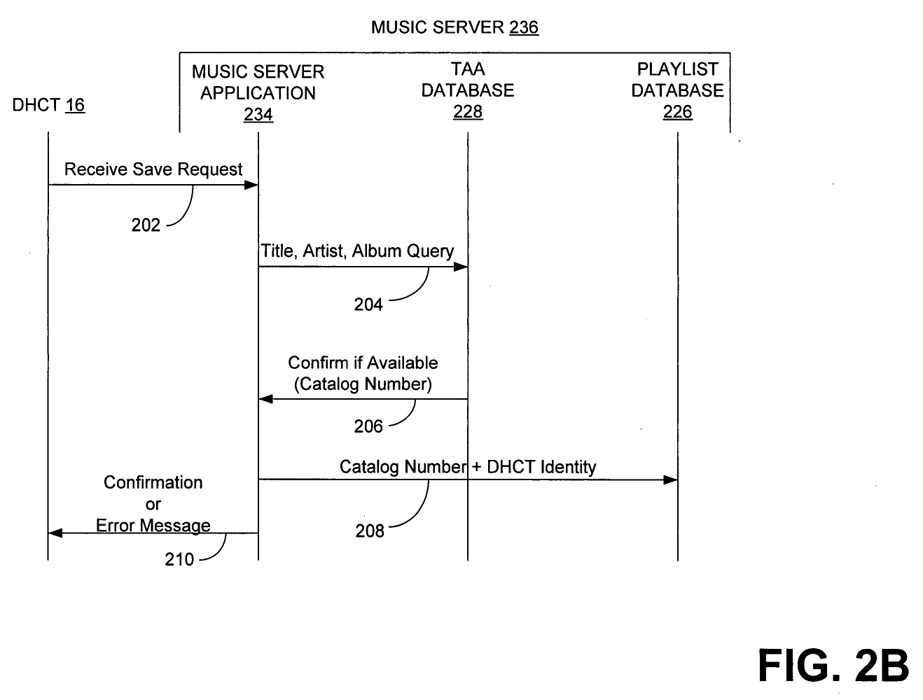

FIGS. 2A-2B illustrate some of the cooperating elements and interactions used to provide a music service, in accordance with one embodiment of the invention. FIG. 2A depicts a non-limiting example of selected components of a headend 11 that is configured in accordance with one embodiment of the present invention. It will be understood that the headend 11 shown in FIG. 2A is merely illustrative and should not be construed as implying any limitations upon the scope of the preferred embodiments of the invention. The headend 11 receives content from a variety of service and content providers (not shown), which can provide input in a variety of ways. The headend 11 combines the content from the various sources and distributes the content to subscribers via the distribution systems of the network 18. The input signals may be transmitted from sources to the headend 11 via a variety of transmission paths, including satellites (not shown) and terrestrial broadcast transmitters and antennas (not shown).

In one implementation, a digital audio service (not shown) broadcasts many different audio channels to the headend 11, which broadcasts the audio channels to consumers for playback. The broadcast channels originate with a programming provider (not shown) who preferably transmits the audio channels to a satellite (not shown). The headend 11 receives the satellite signal and, after processing according to mechanisms described below, transmits a reformatted signal to a plurality of DHCTs, which, in one implementation, decode the signal for playback of the original audio content. In a typical digital audio service, there will be about 40 channels of audio. In one implementation, each audio channel consists of two elementary streams of data. The first elementary stream conveys the audio data to be decoded. The audio data is preferably compressed using a perceptual audio coder such as Moving Picture Experts Group (MPEG) Layer 2 audio or Dolby AC-3 (per Advanced Television Systems Committee audio specifications). The second elementary stream conveys data about the audio data stream. This data can include title, artist, album, and/or label information, among other data. The elementary streams are packetized and assigned to different PIDs preferably in an MPEG-2 transport stream. The elementary streams of many or all of the different audio channels are combined into an MPEG-2 transport stream for delivery to DHCTs.

In some implementations, a third elementary stream can be used. The third elementary stream can carry a series of still images that change, for example, approximately once every eight seconds. These still images convey the same information as the text bitstream but also convey additional information such as graphics related to the currently playing song and/or advertisements.

As shown in FIG. 2A, the selected components of the example headend 11 include a communications interface 212, a digital network control system (DNCS) 216, a music server 236, a conditional access (CA) server 214, a quadrature amplitude modulation (QAM) modulator 240, a quadrature phase shift keying (QPSK) modem 242, and a router 244. It will be understood by those having ordinary skill in the art that the example headend 11 can include additional components, such as additional servers, switches, multiplexers, QAM modulators, among others, or can omit components. In one implementation, the satellite signal is received by the communications interface 212, and the demodulated data can be sent via Ethernet 260 (or in other embodiments, via asynchronous transport mode (ATM), asynchronous system interface (ASI), or some communications protocol for storage on the music server 236) to the music server 236, among other servers. That is, music data in the music data stream sourced via the satellite signal is “recorded” by the music server 236. For example, tags can be embedded in the music data stream that can delineate the beginning and end of songs, using for example MPEG-2 transport splice points or clocking mechanisms inherent to MPEG that are synchronized to the headend clock (not shown). The music server 236 and a plurality of other servers, such as the conditional access server 214, are connected to the DNCS 216 via the Ethernet 260. Stored data in the music server 236 is preferably forwarded to the QAM modulator 240, where it is converted/remodulated to a QAM format for transmission over the network 18.

In another implementation, functionality of the music server 236 and its associated databases (described below) can be implemented external to the headend 11. In such a case, the music data is received via a satellite signal that is received at the communications interface 212, converted to Ethernet (or ASI, DigiCable Headend Expansion Interface (DHEI), etc.), and then routed to the QAM modulator 240 (via connection 261) for transmission to subscribers as a QAM modulated signal. Identifying indicia for instances of music (e.g., songs), such as title and/or artist data, are included by the programming originator at a satellite uplink site (not shown).

In still other implementations, music service functionality is provided by the headend 11 and by locations external to the headend 11. For example, the music server 236 is resident at the headend 11, but supplied with precompressed audio (e.g., tapes, discs, etc.) that has been licensed for installation on the music server 236. Additionally, music can be provided using sources external to the headend 11 as indicated in the last described implementation, wherein the music server 236 is bypassed such that not all the content sourced externally from the headend 11 is available on the music server 236, and vice versa. In still other implementations, the music server 236 can include precompressed audio and can also record music off the music data stream sourced from the satellite signal.

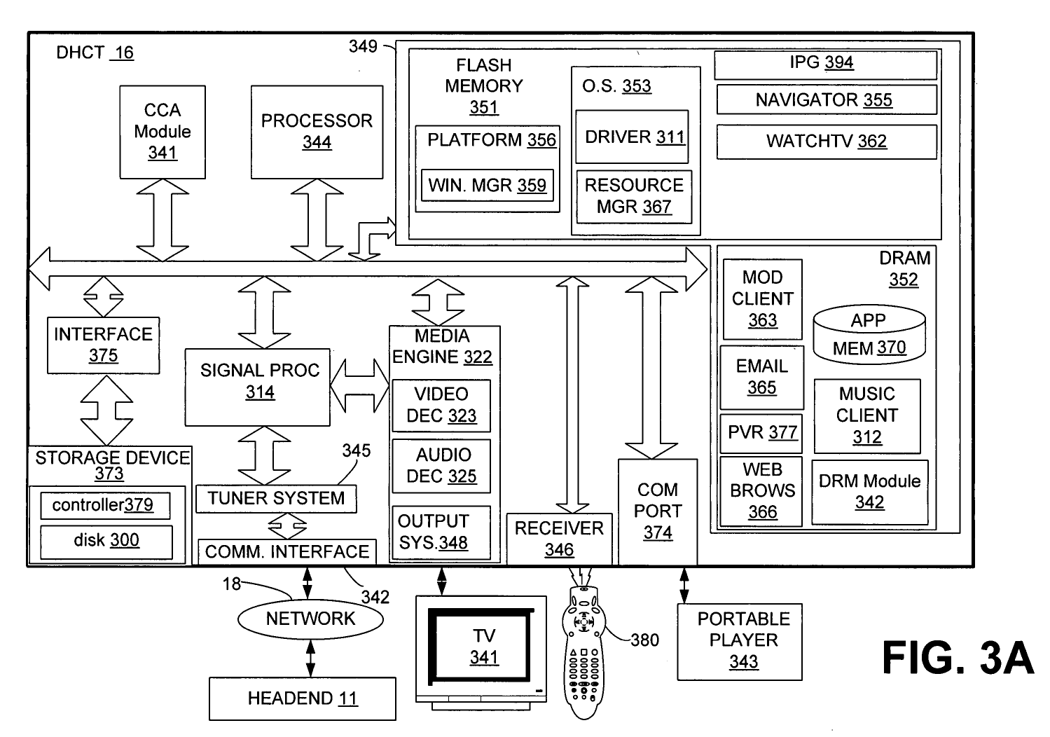

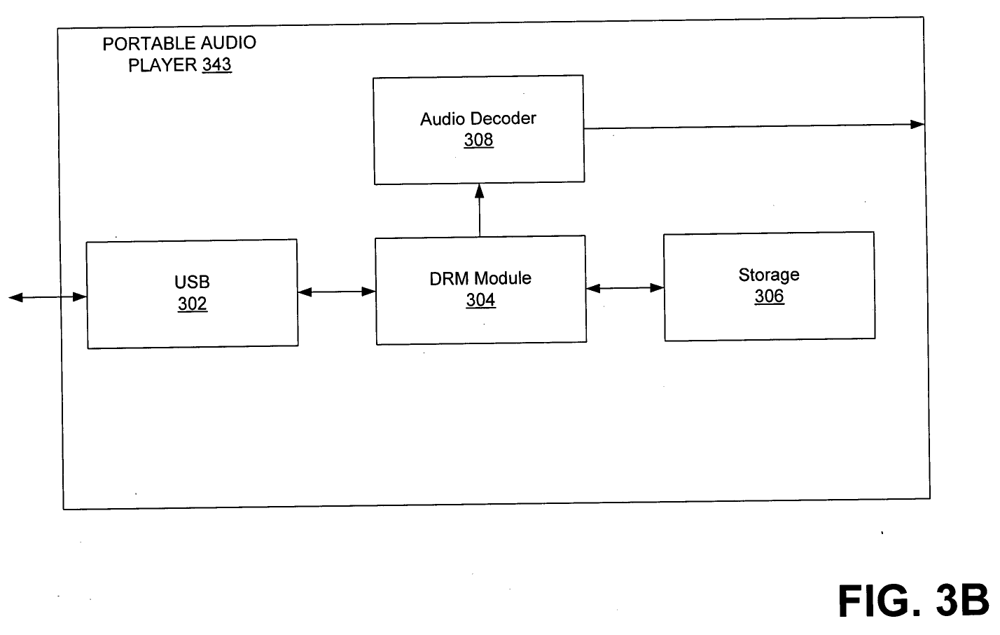

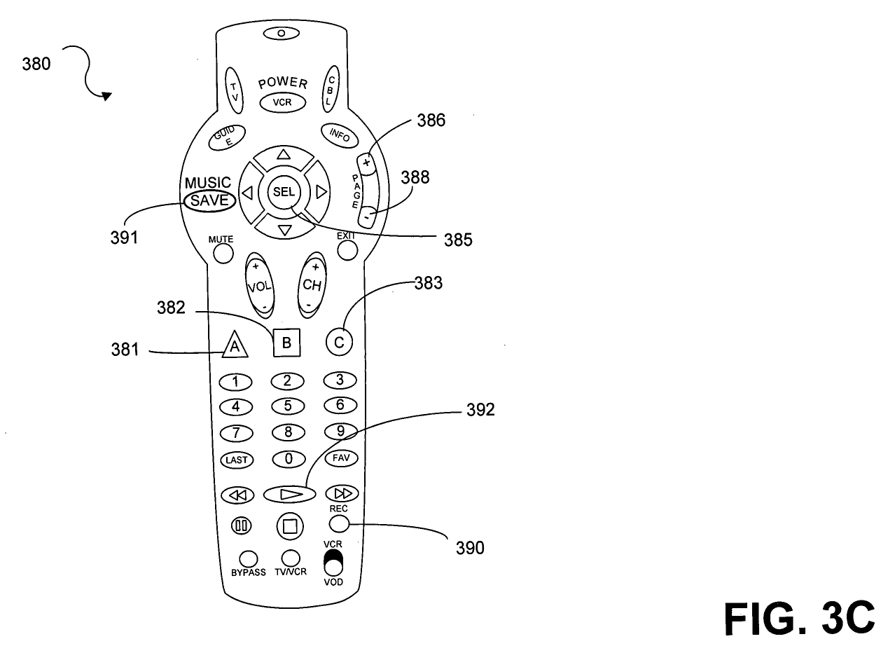

The DNCS 216 provides management, monitoring, and control of network elements and of the broadcast services provided to users. The DNCS 216 includes, among other modules, a subscriber database 218 that includes information about the subscribers in an illuminated region for such purposes as billing information, survey data, among others. The DNCS 216 also communicates with a conditional access server 214 to provide for secure transmittal of content. In one implementation, the DNCS 216 uses a data insertion multiplexer 251 and a data QAM 252 to insert in-band broadcast file system (BFS) data (not shown) into an MPEG-2 transport stream that is broadcast and received via the DHCT communication interface 342 (FIG. 3A) and tuner system 345 (FIG. 3A). The QPSK modem 242 is responsible for transporting the out-of-band IP (Internet protocol) datagram traffic between the distribution headend 11 and the DHCT 16. Data transmitted or received by the QPSK modem 242 may be routed by a headend router 244. The headend router 244 may be used to deliver upstream data to the various server applications, such as the music server application 234.

The music server 236 is preferably run under the control of the music server application 234. The music server 236 includes other modules and databases (i.e., structured data such as a database or data structure) that are used by the music server application 234 to provide the music service, in accordance with one embodiment of the invention. The music server 236 includes, among other modules, a digital rights management (DRM) module 230 that is in communication with an associated DRM database 224, a conditional access (CA) module 232, a compressed music storage 220 for storage of digital files (i.e., a database for the compressed songs), and a plurality of other databases. The DRM module 230 determines what licenses are available for downloadable music content, and produces information that a recipient of the music content, for example a portable player (not shown), can use to decrypt encrypted music content. The CA module 232 uses encryption mechanisms to protect the music content while in transit over the network 18. For each DHCT 16 authorized to use the music service, a unique interactive session key (ISK) preferably is stored in a secure micro (not shown) located at the DHCT 16. At the music server 236, an Entitlement Control Message (ECM) is prepended to the music data and the music data is encrypted using the keys formed by processing the key data in the ECM with the unique ISK. The length of the music data is thus increased by the length of the ECM.

The databases include a title, artist, and album (TAA) database 228 that stores song information including title, artist, album, and/or label information for associated music stored in the compressed music storage 220. Also included is a playlist database 226 for storing identifying indicia or references (e.g., catalog number, as described below) of the songs designated for download by individual subscribers. Note that the databases are preferably located internal to the music server 236, but in other embodiments, one or more of the databases can be external to the music server 236, within or external to the headend 11, such as at the DHCT 16 for example, or at a node or hub (not shown).

The headend 11 includes mechanisms for transporting music to DHCTs over the network 18, including one or more QAM modulators 240, which can deliver songs in a compressed format using MPEG standards and/or formatted using Transmission Control Protocol/Internet Protocol (TCP/IP). MPEG standards include standards for video compression, audio compression, and the transport of data including compressed video, audio, and other data. Compression of audio content can occur, for example, via MPEG, or Dolby Digital audio compression (e.g., AC-3). In one implementation, both MPEG and TCP/IP can be used at the same time, such as a 1:1 broadcast implementation. The transmitted signals carrying the audio content can be modulated on to the coaxial cable of the network 18 using QAM modulation, for example. The QAM signal preferably includes MPEG-2 transport stream packets. Within the MPEG-2 transport stream, just as certain PIDs are assigned to carry audio data packets, certain PIDs can be assigned to carry TCP/IP data packets. As would be appreciated by one having ordinary skill in the art, TCP/IP typically “rides on” some other transport protocol, such as MPEG-2 transport or ATM. In other implementations, the transmitted signals carrying the audio content can be packetized and delivered to a DHCT 16 without using TCP/IP, such as in a 1:1 transmission.

FIG. 2B is a timing diagram that illustrates some of the example interactions between selected elements of the music server 236 at the headend 11 (FIG. 2A) to save identifying indicia in a playlist for one or more songs, as requested by a DHCT 16, in accordance with one embodiment of the invention. After a user selects a song for later download (such as by selecting a save button on a remote control device, as described below), step 202 includes receiving a request at the music server application 234 of the music server 236 from the DHCT 16 to save identifying indicia for the selected song. As is described below, a user can be listening to a song played on a TV set or programmable radio coupled to the DHCT 16, and while listening to the song, the user can request that the particular song be designated for download. The request from the DHCT 16 is preferably formatted by a music client application of a music server-music client pair, as described below. The format of the request includes, in one embodiment, the title, artist, album, and/or label information, as well as the identity of the requesting DHCT 16 (i.e., DHCT identity (ID)). Note that in some implementations, for example, a song can be identified with just the title and artist information. In some embodiments, there may be no identifying information in the request, but the time of the request can be used by the music server application 236 to determine the song that is requested based at least in part on the time of the presentation during which the song was selected. Further note that in some embodiments, the requests for download designation can be cached at the DHCT 16 and then forwarded to the headend 11 at various times, for example periodically during the day (e.g., every hour) or after a detected event, such as when a portable audio player has been connected to the DHCT 16.

The DHCT ID can include a media access control (MAC) address and/or a serial number. The serial number is preferably used to associate customer billing information to the DHCT 16. The MAC address is preferably used to address data packets to the DHCT 16. The DNCS 216 (FIG. 2A) preferably includes a database 218 (FIG. 2A) that lists DHCTs by both MAC address and serial number so the DNCS 216 can convert between the two numbers as needed. In some embodiments, the DHCT ID can include additional user identifications, such as for other family members associated with a particular DHCT 16. Such user identifications can be implemented using a personal identification number (PIN), as one example. The request can come to the music server 236, for example, as an IP request (e.g., using TCP/IP) via the QPSK modem 242 (FIG. 2A).

The music server application 234, in response to receiving the request, preferably queries the title, artist, and album (TAA) database 228 (step 204) using the title, artist, and/or album information provided in the request. The TAA database 228 provides a list of the available audio content (e.g., songs) stored in the compressed music storage 220 (FIG. 2A). Each entry in the list is preferably indexed by a unique catalog number. The use of a catalog number reduces the length of data, and thus enables efficient data storage and reduced data stream length in communications. The catalog number can be reverse looked up to return the title, artist, and/or album information. One purpose of the query is to determine if the song is available for download from the compressed music storage 220.

If the song is available in the compressed music storage 220, this is confirmed in a signal to the music server application 234 (step 206). The confirmation preferably includes the catalog number associated with the title, artist, and/or album information of the song designated for download to use as a reference. Step 208 includes sending the catalog number along with the requesting DHCT ID for storage into an associated playlist for that requesting DHCT subscriber (or other users at the subscriber premises who seek to maintain their own playlists) in the playlist database 226. The catalog number is also the index into the compressed music storage 220 for retrieving audio content.

Step 210 includes sending a confirmation message, or if the song is not available for download, sending an error message, to the requesting DHCT 16. In one embodiment, when the DHCT 16 receives a confirmation message, or an error message, the DHCT 16 invokes a confirmation or error screen (not shown) indicating this fact. In other embodiments, an audio indication (and/or an LED display on the DHCT) confirming the addition to the playlist or an error condition can be provided, with or without the screen.

FIG. 3A is a block diagram illustration of an example DHCT 16 that is coupled to a headend 11, a television 341, and a portable audio player 343, in accordance with one embodiment of the invention. It will be understood that the DHCT 16 shown in FIG. 3A is merely illustrative and should not be construed as implying any limitations upon the scope of the preferred embodiments of the invention. For example, some of the functionality performed by applications executed in the DHCT 16 (such as a media on demand (MOD) application 363) may instead be performed completely or in part at the headend 11 and vice versa, or not at all in some embodiments. The DHCT 16 preferably includes a communications interface 342 for receiving signals (video, audio and/or other data) from the headend 11 through the network 18, and provides reverse information to the headend 11 through the network 18.

The DHCT 16 preferably includes one or more processors, such as processor 344, for controlling operations of the DHCT 16, an output system 348 for driving the television display of the television set 341, and at least one tuner system 345 for tuning into a particular television channel or frequency to present content and for sending and receiving various types of data or content (herein collectively or individually referred to as content) to and from the headend 11 over the network 18. The DHCT 16 may include, in other embodiments, multiple tuners for receiving downloaded (or transmitted) content. The tuner system 345 enables the DHCT 16 to tune to downstream content transmissions, thereby allowing a user to receive digital and/or analog content delivered in the downstream transmission via the subscriber television system. The tuner system 345 includes, in one implementation, an out-of-band tuner for bi-directional QPSK data communication and one or more QAM tuners (in band) for receiving television signals. Additionally, a receiver 346 receives externally generated information, such as user inputs or commands from an input device, such as remote control device 380, or other devices.

The DHCT 16 processes analog and/or digital transmission signals for storage in the storage device 373, and/or for presentation to the television set 341, and/or for downloading to the portable audio player 343. In some embodiments, the storage device 373 can be omitted. The DHCT 16 preferably includes a signal processing system 314 and a media engine 322. The components of the signal processing system 314 are capable of QAM demodulation, forward error correction, and demultiplexing of MPEG-2 transport streams, and parsing of elementary streams and packetized elementary streams. Additional components, not shown, include an analog decoder and compression engine for processing an analog transmission signal and, in one implementation, converting it to compressed audio and video streams that are preferably produced in accordance with the syntax and semantics of a designated audio and video coding method, such as that specified by the MPEG-2 audio and MPEG-2 video ISO (International Organization for Standardization or ISO) standard.

In one implementation, the signal processing system 314 outputs packetized compressed streams and presents them as input for storage in the storage device 373 via an interface 375. In another implementation, parsed elementary streams are presented to a media engine 322 for decompression by a video decompression engine 323 and an audio decompression engine 325, and then presented to the TV set 341 via the output system 348. In implementations where the content is encrypted and/or subject to licensing and/or royalty fee maintenance, the parsed streams can be output from the signal processing system 314 and presented to a client conditional access (CCA) module 341 that preferably includes a secure micro for decryption, and a digital rights management (DRM) module 342 for licensing/royalty fee operations and additional decryption prior to presentation to the media engine 322.

For downloaded music slated for playback on the portable audio player 343, the parsed elementary streams can, in one implementation, bypass the CCA and DRM modules 341 and 342 and be presented to the portable audio player 343 via a communications port 374 preferably configured as a USB connection. At the portable audio player 343, licensing, conditional access, and/or decoding can be performed. One having ordinary skill in the art will appreciate that the signal processing system 314 will preferably include other components not shown, including memory, decryptors, samplers, digitizers (e.g., analog-to-digital converters), and multiplexers, among other components. Further, it will be understood that one or more of the components listed above will interface with the processor 344 and/or system memory 349 (and/or dedicated memory for a particular component), to facilitate data transfer and/or processing of the video and/or audio signal for presentation and/or storage, or downloads to peripheral devices.

One or more programmed software applications are executed by utilizing the computing resources in the DHCT 16. Note that an application typically includes a client part and a server counterpart that cooperate to provide the complete functionality of the application. The applications may be resident in FLASH memory 351 or downloaded (or uploaded) into DRAM 352. Applications stored in FLASH memory 351 or DRAM 352 are executed by the processor 344 (e.g., a central processing unit or digital signal processor) under the auspices of the operating system 353. Data required as input by an application is stored in DRAM 352 or FLASH memory 351 and read by the processor 344 as need be during the course of application execution. Input data may be data stored in DRAM 352 by a secondary application or other source, either internal or external to the DHCT 16, or possibly anticipated by the application and thus created with the application at the time it was generated as a software application, in which case it is preferably stored in FLASH memory 351. Data generated by an application is stored in DRAM 352 by the processor 344 during the course of application execution. DRAM 352 also includes application memory 370 that various applications may use for storing and/or retrieving data.

An application referred to as a navigator 355 is also resident in FLASH memory 351 for providing a navigation framework for services provided by the DHCT 16. The navigator 355 registers for and in some cases reserves certain user inputs related to navigational keys such as channel increment/decrement, last channel, favorite channel, etc. The navigator 355 also provides users with television related menu options that correspond to DHCT functions such as, for example, blocking a channel or a group of channels from being displayed in a channel menu presented on a screen display.

The FLASH memory 351 also includes a platform library 356. The platform library 356 is a collection of utilities useful to applications, such as a timer manager, a compression manager, a configuration manager, a hyper text markup language (HTML) parser, a database manager, a widget toolkit, a string manager, and other utilities (not shown). These utilities are accessed by applications via application programming interfaces (APIs) as necessary so that each application does not have to contain these utilities. One component of the platform library 356 shown in FIG. 3A is a window manager 359.

The window manager 359 provides a mechanism for implementing the sharing of the screen regions and user input. The window manager 359 in the DHCT 16 is responsible for, as directed by one or more applications, implementing the creation, display, and de-allocation of the limited DHCT screen resources. It allows multiple applications to share the screen by assigning ownership of screen regions, or windows. The window manager 359 communicates with the resource manager 367 to coordinate available resources (such as display memory) among different resource consuming processes. Such processes may be directly or indirectly invoked by one or more applications.

In the example DHCT 16 illustrated in FIG. 3A, DRAM 352 includes a music client application 312, a media-on-demand (MOD) application 363, an e-mail application 365, a PVR application 377, and a web browser application 366. It should be clear to one with ordinary skill in the art that these applications are not limiting and merely serve as examples for embodiments of the invention. Furthermore, one or more DRAM based applications may be resident, as an alternative embodiment, in FLASH memory 351. These applications, and others provided by the subscriber television system operator, are top-level software entities on the network for providing services to the user.

An executable program or algorithm corresponding to an operating system (OS) component, or to a client platform component, or to an application, or to respective parts thereof, can reside in and execute out of DRAM 352 and/or FLASH memory 351. Likewise, data input into or output from any executable program can reside in DRAM 352 or FLASH memory 351. Furthermore, an executable program or algorithm corresponding to an operating system component, or to a client platform component, or to an application, or to respective parts thereof, can reside in FLASH memory 351, or in a local storage device (such as storage device 373) externally connected to or integrated into the DHCT 16 and be transferred into DRAM 352 for execution. Likewise, data input for an executable program can reside in FLASH memory 351 or a storage device and be transferred into DRAM 352 for use by an executable program or algorithm. In addition, data output by an executable program can be written into DRAM 352 by an executable program or algorithm and be transferred into FLASH memory 351 or into a storage device. In other embodiments, the executable code is not transferred, but instead, functionality is effected by other mechanisms.

The DHCT 16 can also include one or more wireless or wired interfaces, also called communication ports 374, for receiving and/or downloading content to other devices, such as the portable audio player 343. For instance, the DHCT 16 may feature USB (Universal Serial Bus), Ethernet (for connection to a computer), IEEE-1394 (for connection to content devices in an entertainment center), serial, and/or parallel ports, as well as wireless interfaces such as Bluetooth, among others. FIG. 3B is a block diagram of one example portable audio player 343 that can be connected to the communications port 374 (FIG. 3A) configured as a conventional USB port. Although a portable audio player 343 is described herein, substantially any type of portable player with the same or other connection interfaces is considered to be within the scope of the preferred embodiments, including a portable video player or a dual portable video and audio player. As shown, the portable audio player 343 preferably includes a USB connector 302 for communicating with the DHCT 16, a digital rights management (DRM) module 304 for providing digital rights management, storage 306 for the downloaded music, and an audio decoder 308 for enabling playback of the original audio. It will be understood that the example portable audio player 343 is for illustration only, and that one skilled in the art will understand that the portable audio player 343 can be equipped with additional or fewer components not shown, such as memory, a processor, communication software, and/or other well known portable audio player components. Note that in some embodiments, one or more digital rights management modules will exist at the headend 11 (FIG. 2A) corresponding to different types of portable audio players, and possibly different DRM modules for each content owner.

In one example implementation, each portable audio player 343 has a public private key pair and each server side DRM module 230 (FIG. 2A) has a public private key pair. For each downloaded song, a license is preferably created. The license preferably includes the portable audio player serial number, data encryption standard (DES) key used to encrypt the music content, catalog number of the music content, and/or a message authentication code encrypted with the public key of the portable audio player 343. This license is then signed by the server side DRM module private key. The license is prepended to the stored music data on the portable audio player 343.

The portable audio player 343 verifies the DRM server's signature, decrypts the license, verifies the serial number of the connected portable audio player 343, and then uses the enclosed DES key to decrypt the music content when the portable audio player 343 plays that piece of music content. This DRM scheme can be used to prevent the audio content from being played on any portable audio player other than the one that is attached to the DHCT 16 (FIG. 3A) when the song is downloaded. The DRM module 230 (FIG. 2A) at the server side could track and limit the number of portable audio players per subscriber, per DHCT, etc.

Referring again to FIG. 3A, the DHCT 16 can include at least one storage device 373 to provide storage for downloaded content. The storage device 373 can be an optical storage device or a magnetic storage device, among others, and is preferably a hard disk drive. The storage device 373 comprises storage for content that can be written to for storage and later read from for retrieval for presentation. The storage device 373 preferably includes at least one hard disk 300. Throughout this disclosure, references relating to writing to or reading from the storage device 373, or references regarding recordings from or to the storage device 373 will be understood to mean that such read or write operations are occurring to the actual medium (for example, the hard disk 300) of the storage device 373. The storage device 373 is also comprised of a controller 379 that preferably receives operating instructions from the device driver 311 of the operating system 353 and implements those instructions to cause read and/or write operations to the hard disk 300.

The storage device 373 is preferably internal to the DHCT 16, coupled to a common bus through a communication interface 375, preferably an integrated drive electronics (IDE) interface or small computer system interface (SCSI), although IEEE-1394 or USB can be used. In other embodiments, the storage device 373 can be externally connected to (and thus removable from) the DHCT 16 via the communication port 374 implemented as IEEE-1394 or USB or as a data interface port such as a SCSI or an IDE interface.

In one implementation, the processor 344, in communication generally with the device driver 311 and the storage device controller 379 and the signal processing system 314, effect retrieval of compressed video streams, compressed audio streams, and data streams corresponding to one or more content instances from the storage device 373. Retrieved streams are deposited in an output cache in the storage device 373 and transferred to DRAM 352, and then processed for playback according to mechanisms well known to those having ordinary skill in the art. In some embodiments, one or more content instances are retrieved and routed from the hard disk 300 to the media engine 322 for video and audio decoding simultaneously, and then further processed for eventual presentation on a display device or other device.

The PVR application 377 provides for content recording functionality by enabling the temporary writing to, and if requested, more permanent recording (i.e., relatively permanent) to the storage device 373. The PVR application 377 preferably maintains a data structure, or data record, for every downloaded content instance. This data structure is preferably maintained on the hard disk 300 of the storage device 373, but can also be maintained in memory 349.

The music client application 312 is the client pair of the client server music application pair. The music client application 312 includes functionality that enables a user to designate a currently playing song for an immediate or future download. In one implementation, the user can be listening to a song played on the TV set or other device. Upon hearing a song that he or she likes, the user can designate the song for download using an input device such as a remote control device 380.

An example remote control device 380 to provide input to the DHCT 16 is illustrated in FIG. 3C. A record button 390 enables the user to designate as permanently recorded any content instance buffered into the storage device 373 (FIG. 3A), or to schedule recordings. A playback button 392 enables the playback of a content instance. “A” 381, “B” 382, and “C” 383 buttons can correspond to certain application-defined functions that have a corresponding “A”, “B”, or “C” symbol displayed in a graphic user interface (GUI) presented on a display device. The select button 385 can be used to enable a user to select among choices from a GUI screen. The music save button 391 enables a user to designate a currently playing song for download from the headend 11 (FIG. 2A). Alternatively, the same or similar functionality of the music save button 391 can be integrated into a multipurpose button such as the select button 385, an enter button (not shown), or the record button 390 while tuned to the digital music channel, among other buttons. The example remote control device 380 also includes page up 386 and page down keys 388 to alternate between television screens. Many alternative methods of providing user input may be used including a remote control device with different buttons and/or button layouts, a keyboard device, a voice activated device, etc. The preferred embodiments of the invention described herein are not limited by the type of device used to provide user input.

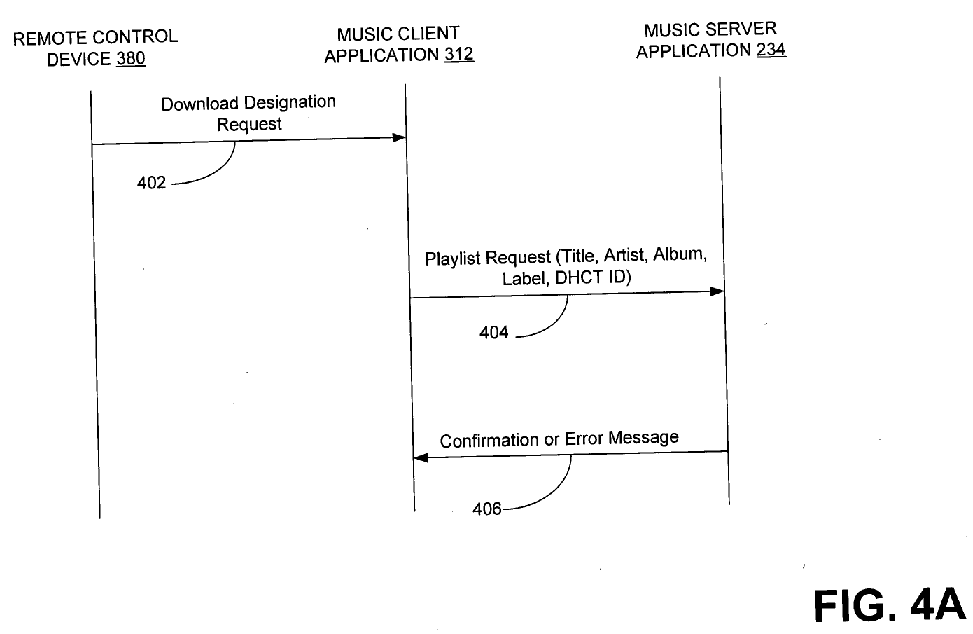

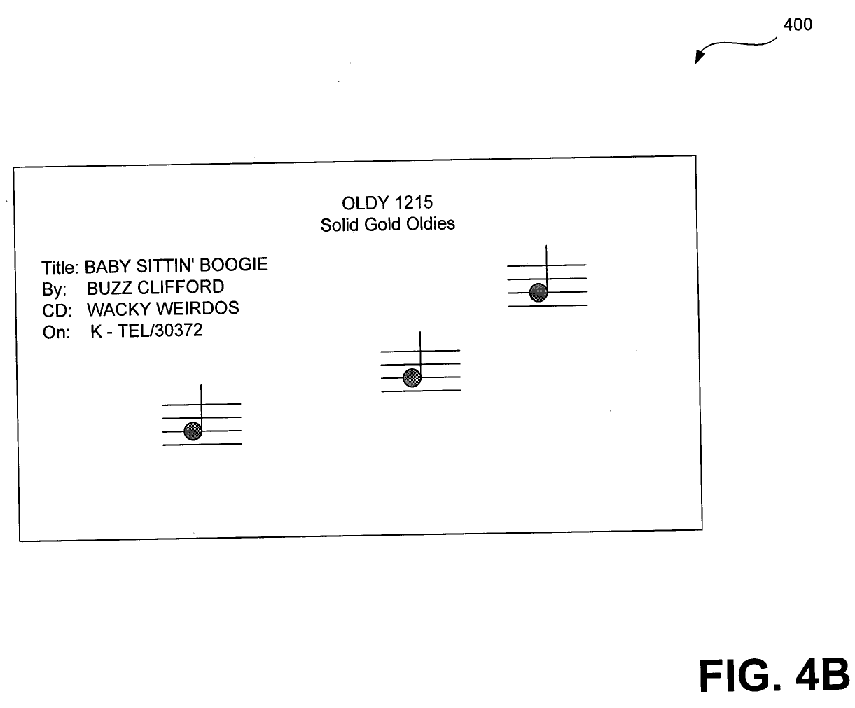

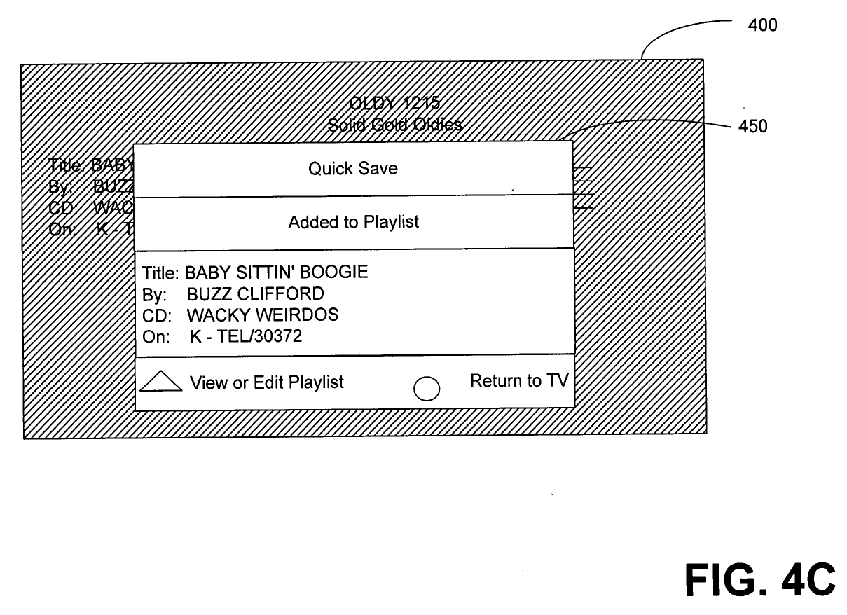

FIG. 4A is a timing diagram that illustrates one mechanism of the preferred embodiments for saving a song that is currently being played. As shown in FIG. 4A, the music client application 312 of the DHCT 16 (FIG. 3A) receives a user request that designates a currently playing song for download (step 402). In one implementation, the currently playing song can be transported in an elementary stream of a transport stream delivered from the headend 11 (FIG. 2A). This elementary stream is preferably retrieved by the music client application 312 in cooperation with functionality performed at the signal processing system 314 (FIG. 3A), along with the elementary stream that includes the title, track, and/or artist information. As one example, the user could be listening to the song from a room where the TV screen is out of view, or the user could be listening to a programmable radio that is coupled to the DHCT 16. In other embodiments, the title, track, and/or artist information, or a catalog number, can be included in a vertical blanking interval (VBI). This information can be used, for example, when the user designates a song associated with a current analog program (e.g., a song that is associated with a currently playing music video), to add information to a playlist.

In other embodiments, the user can be situated in front of a screen display, such as the example music screen 400 shown in FIG. 4B. As shown, the example music screen 400 preferably includes the title, artist, and album of the currently playing song. The example music screen 400 includes a background which suggests to the user the service under current implementation, such as musical notes for the music service. In other embodiments, the example music screen 400 can include such backdrops as mountain scenes, streams, among other backdrops, preferably provided via a third elementary stream as described above. The music client application 312 (FIG. 3A) remembers the currently playing song as well as the previously played song. The title, artist, and/or album information for the previous track and the current track can be alternately displayed by pressing the page up buttons 386 and the page down buttons 388 on the remote control device 380 (FIG. 3C).

In one implementation, referring again to FIG. 4A, the title, artist, and/or album information (i.e., identifying indicia) is sent in a playlist request (step 404), along with the DHCT ID of the requesting DHCT 16 (FIG. 3A), to the music server application 234 at the headend 11 (FIG. 2A) in response to receiving the user designation request. As described above, the music server application 234 determines if it can supply the song designated for download by the user, and if it can, stores the title, artist, and/or album (or catalog number of the title, artist, and/or album) in the playlist database 226 (FIG. 2A). If the previously played song is displayed and the music save button 391 (FIG. 3C) is pressed, everything operates substantially the same as described above for the currently playing song except that the music server application 234 attempts to add the identifying indicia associated with the previously played song to the playlist instead of the identifying indicia of the currently playing song. In other implementations, the playlist can be maintained at the DHCT 16 (for example, in the storage device 373, FIG. 3A), and later sent to the music server application 234 to fulfill a music download. A DHCT located playlist could allow, in some implementations, a favorites icon or playlist icon to be presented to the user when a song was playing that was already on the user's playlist. Note that with multiple users and multiple portable audio players 343 (FIG. 3B), there can be multiple playlists, and thus for some implementations, a mechanism such as a displayed dialog box, can be used to ascertain what particular playlist is the identifying indicia associated with the currently playing song being saved to.

Step 406 includes receiving feedback from the music server application 234 that the designated song is available, or if it is not available, or if there are other errors in the processing of the save request, feedback is provided for those situations as well. FIG. 4C shows one example playlist confirm screen 450 that provides the user with a confirmation that the identifying indicia of the designated song has been successfully added to his or her playlist. The example playlist confirm screen 450 is preferably overlaid on the example music screen 400 (in one implementation, altered in appearance to provide distinction to the user) also shown in FIG. 4B, although not necessarily a limitation, and includes a message that conveys to the user that the identifying indicia of the designated song has been added to the playlist, and also includes title, artist, and/or album information, as well as various button icons to suggest defined functionality corresponding to one or more buttons on the remote control device 380 (FIG. 3C). If the user does not select one of the buttons corresponding to the displayed button icons on the screen 450, the screen 450 will preferably time out after a defined period (e.g., 30 seconds).

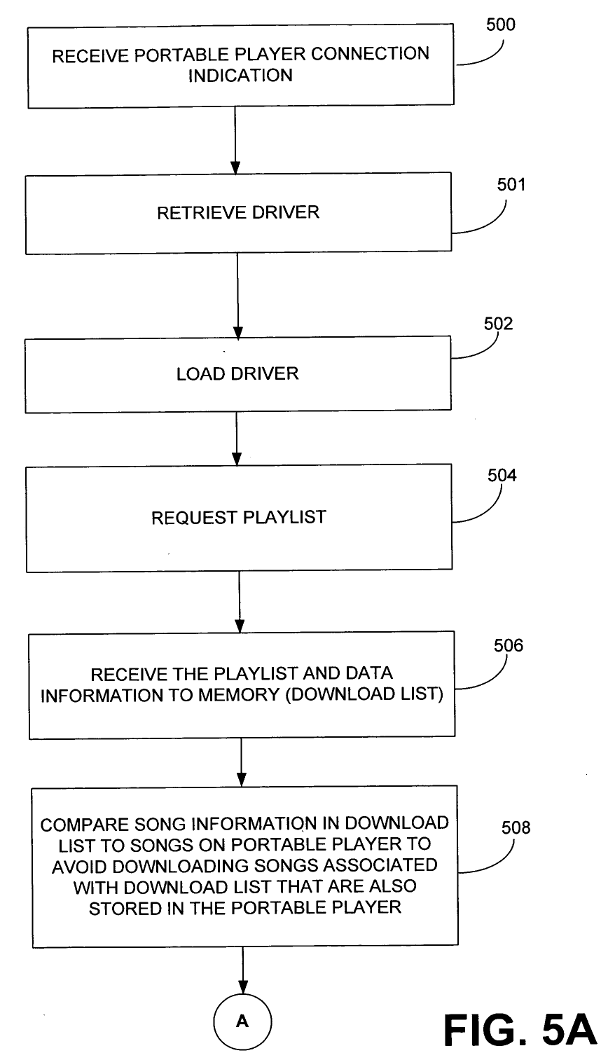

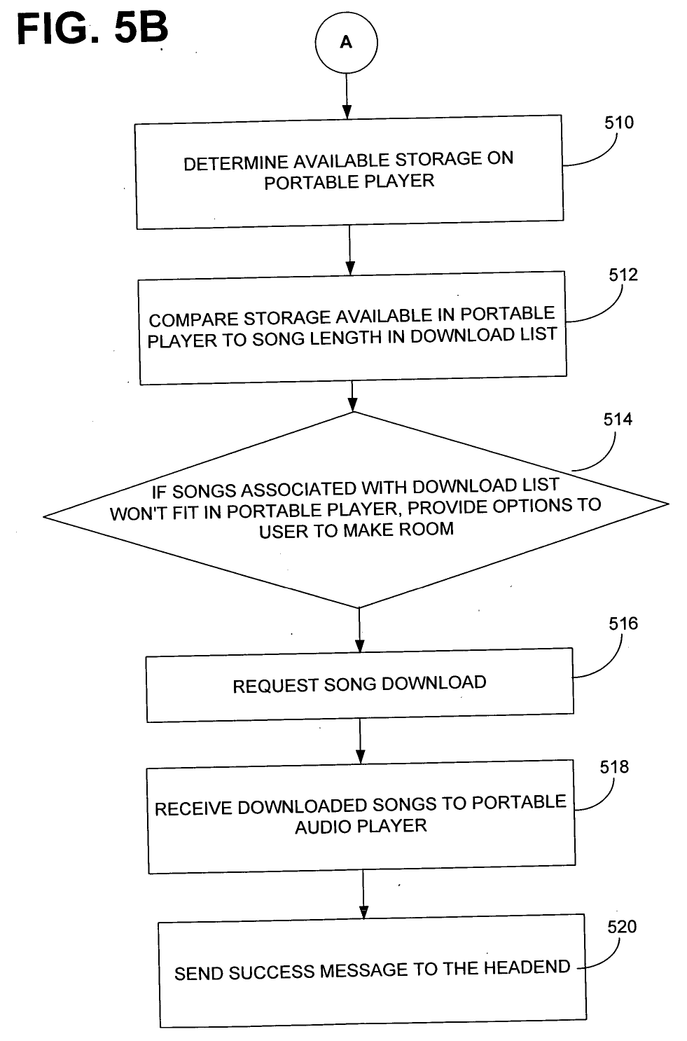

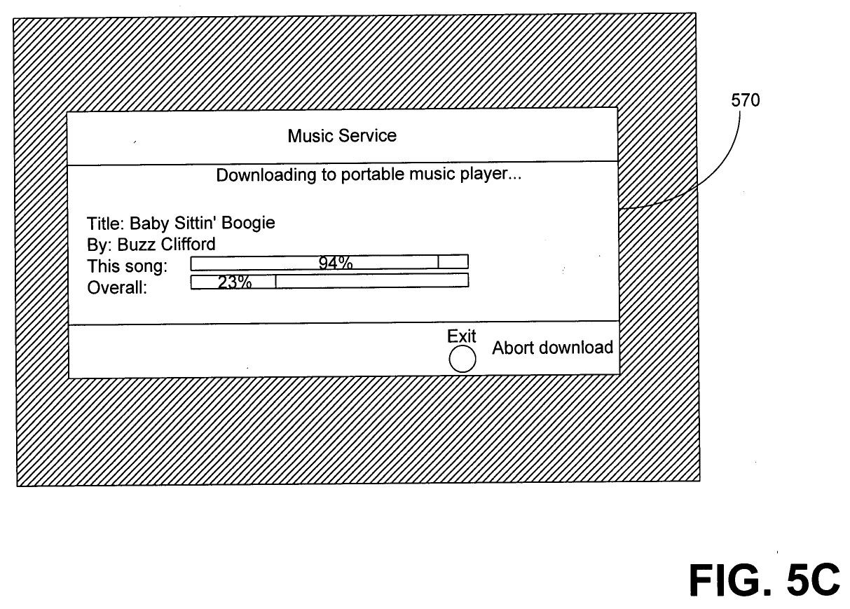

The preferred embodiments of the invention enable a user to repeatedly select the music save button 391 (FIG. 3C) throughout the course of a day (or longer) to add identifying indicia of the designated songs to his or her playlist. In other embodiments, the user can create playlist categories to automatically detect and designate desired songs (and save the corresponding identifying indicia), or to automatically save to a previously defined category upon manually designating the songs. Further embodiments can include the ability to configure the presentation of designated video and/or audio content of different presentation durations (e.g., 2-hours of video, 1 hour of music, etc.). Such an implementation can be administered through the use of a configuration screen (not shown) enabled by the music client application 312 or the music server application 234. Downloads are preferably initiated by the user connecting a portable audio player 343 (FIG. 3B) to the DHCT communications port 374 (FIG. 3A). FIGS. 5A-5B are flow diagrams of one example method for receiving a download of songs to the portable audio player 343. The blocks in the flow diagrams of FIGS. 5A-5B should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

With continued reference to FIGS. 3A and 3C throughout the description of FIGS. 5A-5B, step 500 includes receiving an indication that the portable audio player 343 has been connected. For example, when the user connects his or her portable audio player 343 to the communication port 374 of the DHCT 16, an interrupt is generated and the operating system 353 advises the music client application 312 of the connection event. In other embodiments, well known polling mechanisms can be employed. Step 501 includes retrieving the device driver for the identified portable audio player 343 from the headend 11 (FIG. 2A). Step 502 includes loading the device driver for the identified portable audio player 343 from the headend 11 (FIG. 2A). In one embodiment, a suite of device drivers for different portable audio player manufacturers can be stored at the headend 11, accessible by the music client application 312. In another embodiment, the DHCT 16 can store one or more device drivers for different manufacturers in memory 349 or in the storage device 373 (if the DHCT is equipped with a storage device 373). These device drivers could be downloaded to the DHCT 16 from the headend 11 at start-up and updated periodically, or on an as needed basis. With a device driver available, the music client application 312 can begin the process to download songs from the headend 11 to the portable audio player 343. In one implementation, the DHCT can display a message indicating that downloading is about to begin.

In other embodiments, the DHCT firmware (e.g., operating system 353, FIG. 3A) can register the portable audio player 343 and load the appropriate device driver for the portable audio player 343, either from the headend 11 or the DHCT 16. In the firmware embodiment, once the driver is loaded, the operating system 353 can load the music client application 312 (i.e., if the music client application 312 is not currently being implemented) and signal to the music client application 312 that the portable audio player 343 has just been connected.

Step 504 includes requesting the playlist from the playlist database 226 (FIG. 2A) at the headend 11 (FIG. 2A). In some embodiments, the playlist can be stored and thus retrieved locally (e.g., in DHCT memory 349 or the storage device 373). In such locally stored playlist embodiments, the same or similar process described herein for FIGS. 5A-5B would continue, starting at step 508. Assuming the playlist is located at the playlist database 226 at the headend 11, the music client application 312 begins a series of transactions with the music server application 234 (FIG. 2A) to retrieve the playlist and copy it to DHCT memory, for example DRAM 352. In the playlist request, the music client application 312 includes the DHCT ID to reference the associated playlist, and also indicates the format and bitrate capabilities of the attached portable audio player 343 (provided via the USB connector 302 and interrogated by the device driver used for communicating with the portable audio player 343) to the music server application 234 at this point. The music server application 234 then uses the playlist database 226 and the TAA database 228 (FIG. 2A) to respond to the requesting DHCT 16.

Step 506 includes receiving the requested information to DHCT memory via the in-band (e.g., QAM) or out-of-band (e.g., QPSK) signal path. In some embodiments, the playlist can be included in the vertical blanking interval (VBI) of an analog broadcast signal. The information preferably includes the song title, artist, album, and/or a catalog number for indexing into the compressed music storage 220 (FIG. 2A), as well as the length of the song data. The catalog number and length of song data are reflected by the format and bitrate selection performed by the music server application 234 (FIG. 2A) based on the capabilities of the connected portable audio player, any preferences set by the user (e.g. sound quality), and/or any requirements (unprotected vs. encrypted for digital rights management) and/or preferences (e.g., MP3, AAC (advanced audio coding), Windows Media, etc.) imposted by the music server application 234. In other words, the user can have his or her preferences regarding quality, the content owner can have some requirements based on licensing policies, and the digital audio player has certain technical capabilities. These items are preferably communicated to the music server application 234. The music server application 234 preferably uses an algorithm to select the optimum content that meets the user preferences while fulfilling the licensing and technical requirements for download and playback. In one implementation, server side preferences and requirements are dictated by the format or formats of the songs stored at the headend 11 (FIG. 2A) and licensing restrictions by copyright holders.

The local copy of the playlist and related size and format information is referred to as the download list. The music client application 312 compares the song information in the download list with the songs that are already stored on the portable audio player 343 (step 508). The songs on the portable audio player 343 can be ascertained via a directory listing of the portable audio player 343 invoked by the DHCT device driver used to communicate with the portable audio player 343. Any songs that are already in the portable audio player 343 are preferably marked as already existing in the portable audio player 343 and will preferably not be downloaded to the portable audio player 343 again.

In other embodiments, the download from the headend 11 (FIG. 2A) can occur without retrieving the playlist for use in DHCT memory, which can result in overwriting some or all of the content currently on the portable audio player 343. In other embodiments, a portable audio player can handle the selection and/or paring down of songs to fit on the portable audio player. For example, the portable audio player may include a larger LCD display which enables the user to do the selecting and/or paring. For example, a cell phone/MP3 player combination device may provide for this functionality.

FIG. 5B continues the described method from where it left off at connector A in FIG. 5A. In one implementation, the music client application 312 queries the portable audio player 343 (step 510) for its block size, number of free blocks, number of overhead blocks per added song, and minimum number of free blocks. The length of each song referenced on the download list is then computed in terms of block size, and the music client application 312 determines if all of the songs referenced on the download list will fit in the portable audio player 343 (step 512). In one implementation, if there is inadequate storage space, the music client application 312 displays a dialog box (not shown) to the user (step 514) indicating the storage constraint and allowing him to either (i) use a playlist editor to remove references to the designated songs from the playlist, (ii) erase the entire contents of the player (if the playlist will fit when the player is empty), or (iii) abort the download. Once all songs will fit on the portable audio player 343, the downloading process can begin.

Step 516 includes requesting that the songs referenced in the playlist be downloaded to the portable audio player 343. For each song to be downloaded to the portable audio player 343, the music client application 312, preferably using the catalog number as an index, requests the songs from the music server application 234 (FIG. 2A). The music server application 234 retrieves the song information from the compressed music storage 220 (FIG. 2A) and passes the identity of the requesting DHCT 16, the identity of the portable audio player 343, and song data to the DRM module 230 (FIG. 2A) and the CA module 232 (FIG. 2A). The DRM module 230 is given an opportunity to negotiate keys and license fees with the portable audio player 343, perform any encryption needed for digital rights management functions, and passes the data back to the music server application 234. The DRM module 230 can decrypt music content if the music content is stored encrypted in the compressed music storage 220. The CA module 232 performs any encryption needed to protect the song while in transit over the HFC network 18 (FIG. 1). The data is then passed back to the music server application 234.

Step 518 includes receiving the possibly decrypted, re-encrypted, and encrypted again songs (i.e., song in data format, or herein, song data) from the music server application 234 (FIG. 2A). The download can be formatted according to Transmission Control Protocol/Internet Protocol (TCP/IP), MPEG, Data Over Cable Service Interface Specification (DOCSIS), among other protocols, and delivered as a broadcast, or in other embodiments, via a dedicated cable modem or in-band data path similar to that used for video on demand. The download of the song data can be implemented in sequential fashion, or batched into a single file (that can incorporate advertisements and other information), or for implementations using DHCTs equipped with storage devices, the download can include “trickle” type downloads to the storage device 373 (FIG. 3A) over an extended period of time. In one implementation, a dialog box can be displayed, such as the example dialog box 570 shown in FIG. SC. The example dialog box 570 can provide visual feedback regarding the status of the download of songs referenced in the user playlist. Other feedback mechanisms can be employed, including a light emitting diode (LED) indication at the DHCT 16, among others. In other implementations, a dialog box need not be displayed. Further, the TV set 341 does not need to be on for the download to occur.

While the DHCT 16 is receiving the downloaded song data, in one implementation, the received song data can be routed to the DHCT client conditional access (CCA) module 341 (FIG. 3A) to remove any conditional access related encryption. In other implementations, the downloaded song data can remain encrypted (by the server-side DRM module 230, FIG. 2A) as it is routed to the portable audio player 343. Note that in some embodiments, downloading to the portable player may require some throttling of the data rate at the headend 11 (FIG. 2A) due to rate constraints at the USB connection of the portable audio player 343. In other embodiments, the protocol used to download the song data may inherently include such data rate throttling mechanisms, such as TCP/IP for example. Once each song is downloaded, a success message is preferably passed to the music server application 234 (FIG. 2A) (step 520), which can include information pertaining to what content was downloaded. The music server application 234 can store and then use this information to create top ten lists for marketing purposes, target advertisements to the end user, bill the user for each song downloaded, or other functions. Once all songs have been downloaded from the headend 11 (FIG. 2A) to the portable audio player 343, the DRM modules at the headend 11 and in the portable audio player 343 can be given another opportunity to negotiate any licenses required by the portable audio player 343 to use the downloaded content.

Note that negotiating licenses includes looking at what licenses are available, and producing the information required to decrypt the encrypted audio content that was just downloaded to the portable audio player 343 (FIG. 3B). This information is then sent to the portable audio player 343 and stored so that the portable audio player 343 can use it to decrypt the encrypted content when the user requests the portable audio player playback of the song. With regards to royalty fees, the server side DRM is preferably tracking which songs are played, and how often they are played. This information can then be used by the content owner to bill the cable system operator for use of his content, or by the cable operator for billing end users for the used content.

In other embodiments, particularly with DHCTs including coupled storage devices, the songs of the playlist could be played back at the DHCT 16 (FIG. 3A). Similar actions occur to the steps described above. Transport may be either TCP/IP, or for real-time performance, an MPEG-2 transport mechanism similar to video on demand could be used, as described above. The music client application 312 (FIG. 3A) preferably displays the current song title, artist, album, and/or label information. In some embodiments, the user can be given an opportunity to remove references to the song from the playlist while the song is playing (e.g., via a playlist editor, for example). Using a playlist editor, the user can move forward and backward in the playlist. When the playlist is complete, the DHCT 16 can either repeat the playlist or return to the tuned TV channel.

Other embodiments include a host of different options, including the ability to repeat each song and randomize the order of songs referenced on the playlist. The songs could also be saved in the storage device 373 (FIG. 3A) for later playback. In some embodiments, the user could be given options to enter a playlist editor, set preferences, etc. In other embodiments, the title, artist, and album screen (e.g., example music screen 400, FIG. 4B) can be shown during the first 15 seconds and the last 15 seconds of each song or when a button on the remote control is not pressed for two minutes to prevent ruining televisions. Other embodiments can omit the “handshaking” involved in negotiating licenses or determining authorization for downloading to the portable audio player 343 (FIG. 3C), depending on the vendor, as one example. In some embodiments, the determination of audio content currently on the portable audio player 343 along with the associated dialog boxes may be omitted in favor of overwriting any existing audio content, for example as configured in a user configuration screen (not shown).

The operating system 353, music client application 312, and the music server application 234 and associated modules can be implemented in hardware, software, firmware, or a combination thereof. In the preferred embodiment(s), the operating system 353, music client application 312, and the music server application 234 are implemented in software or firmware that is stored in a memory and that is executed by a suitable instruction execution system. If implemented in hardware, as in an alternative embodiment, the operating system 353, music client application 312, and the music server application 234 may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The operating system 353, music client application 312, and the music server application 234, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments of the present invention, particularly, any “preferred embodiments” are merely possible examples of implementations, merely setting forth a clear understanding of the principles of the inventions. Many variations and modifications may be made to the above-described embodiments of the invention without departing substantially from the spirit of the principles of the invention. All such modifications and variations are intended to be included herein within the scope of the disclosure and present invention and protected by the following claims.

1-28. (canceled)

29. A method for downloading content to a portable player, the method comprising the steps of:
receiving a user request from a user to designate a content instance for download, the user request received during a presentation of the content instance;
responsive to receiving the user request, requesting that a remote server save identifying indicia of the content instance, wherein the identifying indicia includes at least one of title, artist, album, and label information associated with the content instance;
receiving an indication at a media client device that a portable player is interfacing with the media client device, wherein the portable player includes at least one of an audio portable player, an audio and video portable player, and a video portable player;
responsive to receiving the indication, requesting the remote server to download the content instance associated with the saved identifying indicia to the media client device;
receiving the content instance associated with the saved identifying indicia at the media client device; and
downloading the content instance associated with the saved identifying indicia to the portable player.

30. A method for downloading content to a portable player, the method comprising the steps of:
receiving a user request from a user to designate a content instance for download, the user request received during a presentation of the content instance;
responsive to receiving the user request, saving identifying indicia of the content instance at a media client device of the user;
receiving an indication at the media client device that a portable player is interfacing with the media client device; and
responsive to the indication, requesting the remote server to download the content instance associated with the saved identifying indicia to the media client device.

31. The method of claim 30, further including the steps of receiving the content instance associated with the saved identifying indicia at the media client device and downloading the content instance to the portable player.

32. The method of claim 30, wherein the identifying indicia includes at least one of title, artist, album, and label information associated with the content instance.

33. The method of claim 30, wherein the step of saving includes the step of saving the identifying indicia in at least one of memory at the media client device and a storage device associated with the media client device.

34. The method of claim 30, wherein the steps of receiving, saving, and requesting are repeated for a plurality of content instances presented to the user.

35. The method of claim 30, wherein the step of receiving a user request includes receiving a keypress indication resulting from the user selecting a single button on a remote control device.

36. The method of claim 35, wherein the button includes at least one of a save button, a select button, an enter button, and a record button.

37. A method for downloading content to a portable player, the method comprising the steps of:
receiving an indication at a media client device that a portable player is interfacing with the media client device; and
responsive to the indication, requesting a remote server to download a content instance stored at the remote server.

38. The method of claim 37, further including the step of receiving the downloaded content instance at the media client device.

39. The method of claim 37, further including the step of downloading the content instance to the portable player.

40-67. (canceled)

68. A system for downloading content to a portable player, the system comprising:
a memory with logic; and
a processor configured with the logic to receive a user request from a user to designate a content instance for download, the user request received during a presentation of the content instance, wherein the processor is further configured with the logic to, responsive to receiving the user request, request that a remote server save identifying indicia of the content instance, wherein the identifying indicia includes at least one of title, artist, album, and label information associated with the content instance, wherein the processor is further configured with the logic to receive an indication at a media client device that a portable player is interfacing with the media client device, wherein the portable player includes at least one of an audio portable player, an audio and video portable player, and a video portable player, wherein the processor is further configured with the logic to, responsive to receiving the indication, request the remote server to download the content instance associated with the saved identifying indicia to the media client device, wherein the processor is further configured with the logic to receive the content instance associated with the saved identifying indicia at the media client device, wherein the processor is further configured with the logic to download the content instance associated with the saved identifying indicia to the portable player.

69. A system for downloading content to a portable player, the system comprising:
a memory with logic; and
a processor configured with the logic to receive a user request from a user to designate a content instance for download, the user request received during a presentation of the content instance, wherein the processor is further configured with the logic, responsive to receiving the user request, save identifying indicia of the content instance at a media client device of the user, wherein the processor is further configured with the logic to receive an indication at the media client device that a portable player is interfacing with the media client device, wherein the processor is further configured with the logic to, responsive to the indication, request the remote server to download the content instance associated with the saved identifying indicia to the media client device.

70. The system of claim 69, wherein the processor is further configured with the logic to receive the content instance associated with the saved identifying indicia at the media client device and download the content instance to the portable player.

71. The system of claim 69, wherein the identifying indicia includes at least one of title, artist, album, and label information associated with the content instance.

72. The system of claim 69, wherein the processor is further configured with the logic to save the identifying indicia in at least one of memory at the media client device and a storage device associated with the media client device.

73. The system of claim 69, wherein the processor is further configured with the logic to receive, save, and request for a plurality of content instances presented to the user.

74. The system of claim 69, wherein the processor is further configured with the logic to receive a keypress indication resulting from the user selecting a single button on a remote control device.

75. The system of claim 74, wherein the button includes at least one of a save button, a select button, an enter button, and a record button.

76. A system for downloading content to a portable player, the system comprising:
a memory with logic; and
a processor configured with the logic to receive an indication at a media client device that a portable player is interfacing with the media client device, wherein the processor is further configured with the logic to, responsive to the indication, request a remote server to download a content instance stored at the remote server.

77. The system of claim 76, wherein the processor is further configured with the logic to receive the downloaded content instance at the media client device.

78. The system of claim 76, wherein the processor is further configured with the logic to downloading the content instance to the portable player.

79. (canceled)
